(19) United States
(12) Patent Application Publication
(10) Pub. No.: US 2003/0041143 A1
(43) Pub. Date: Feb. 27, 2003

(54) Internet tool

(76) Inventors: Simon Paul Ronald, Adelaide (AU); Richard John Webber, North Lambton (AU); Stephen Dennis Kirkby, Norwood (AU)

Correspondence Address: Carl M Napolitano, Allen Dyer Doppelt Milbrath & Gilchrist, 255 South Orange Avenue Suite 1401, PO Box 3791, Orlando, FL, 32802-3791, US

(21) Appl. No.: 10/149,629

(22) PCT Filed: Dec. 4, 2000
(86) PCT No.: PCT/AU00/01496

(51) Int. Cl. G06F 15/173; G06F 15/16

(52) U.S. Cl. 709/224; 709/203

(57) ABSTRACT

The present invention provides a method and a system for providing profile information about at least one internet user. The profile information is provided to users of the internet, and may also be provided to a third party. The profile information may be used by a user to view their own web-surfing habits, and may allow the surfing habits of particular demographic groups of a site or set of web sites to be examined. For example, parents may use the profile information to monitor the internet usage of children. Preferably, profile information provided to any party is presented as summarised demographic information about a selection of users, rather than personal details about any single user. However, a user may be given access to their own personal details. The present invention also provides a display system including means for graphically displaying a navigation history of an internet user. The display system may construct a visual display of the navigation history using history data provided by a web browser.

### TECHNICAL FIELD

The present invention provides a method and a system for obtaining demographic information about network users, particularly, but not exclusively, users of public access networks such as the internet.

### BACKGROUND OF THE INVENTION

There are currently many internet products which provide platforms for displaying notices advertisements or promotions to internet users. Some products encourage use by providing one or more free services, such as an email account. Advertising and promotions are commonly distributed indiscriminately over the internet without regard to the demographic profile of each user since a reliable source of such information can be difficult to obtain. Demographic profile information may include, but is not limited to, information about each user's age, sex, employment, education, income, interests, or purpose for using the internet. However, internet users are understandably hesitant to divulge this type of information as it is of a private nature. There is therefore a need for methods and systems which encourage internet users to willingly divulge at least some types of demographic profile information.

A significant problem faced by internet users is how to find topics and web pages that will interest them. Internet users currently use search engines and survey pages in order to locate areas of the internet that may be useful and relevant. However, search engines are notoriously difficult to use as a given search request may return thousands of hits according to the complexities of the search-ranking system. Survey pages may be commercially biased, out of date or incomplete.

Throughout this specification, unless the context requires otherwise, the word “comprise” or variations such as “comprises” or “comprising”, will be understood to imply the inclusion of a stated element or integer or group of elements or integers but not the exclusion of any other element or integer or group of elements or integers.

### SUMMARY OF THE INVENTION

A first aspect of the invention provides a system for providing profile information about at least one internet user, the system comprising:

at least one receiving means for receiving internet usage information and registration information about each of the at least one internet users;

a profile generating means for generating a profile data set for each of the at least one internet users from the registration information and internet usage information;

an information providing means for providing at least one party with profile information obtained from at least one profile data set, wherein the at least one party includes each of the at least one internet users.

A second aspect of the invention is a method of providing profile information about at least one internet user, the method comprising the steps of:

receiving registration information from each of the at least one internet users;

receiving internet usage information about each of the at least one internet users;

generating a profile data set for each user from the registration information and internet usage information;

providing at least one party with profile information obtained from at least one profile data set, wherein the at least one party includes each of the at least one internet users.

The at least one party may further comprise a third party in addition to the users. The present invention has the advantage of offering each user summary demographic information about the surfing habits and interests of other users who have also registered, thereby giving each user an incentive to supply their registration and internet usage information. The profile information may be used by a user to view their own web-surfing habits, and may allow the surfing habits of particular demographic groups of a site or set of web sites to be examined. For example, parents may use the profile information to monitor the internet usage of children. Preferably, profile information provided to any party is presented as summarised demographic information about a selection of users, rather than personal details about any single user. For example, the profile information may be presented in a statistical format. However, a user may be given access to their own personal details.

Although the internet provides a vast repository of information, a user of the internet is frequently faced with the challenge of filtering out masses of irrelevant information in order to locate a small amount of useful information. The profile information provided to users may include the sites or links used by other users with the same demographic profile and interests and can therefore speed up a user's search for information about a particular topic. For example, a user may use the profile information to assist in answering questions such as, “what are the most popular web sites relating to the topic of computer programming which are frequented by people with the same demographic background as myself?”

Registration information may be voluntarily supplied by a user and may include personal details about the user, such as age, sex, employment history, income level, geographical location, interests, educational background, or family makeup. The registration information may be provided in conjunction with downloading a new software product. The registration information may alternatively be provided via a warranty card filled out by a user after the purchase of a new product, or via a survey form. The internet usage information may be a record of an internet site visited by a user. Preferably, the internet usage information comprises a record of each hyperlink clicked on by a user when using a particular web browser. The internet usage information may provide detailed information on web usage patterns both between and within web sites.

Preferably, the user should explicitly approve that the registration information and internet usage information will become part of profile information about the user, and that at least part of the information may be conveyed to other parties. All profile information should be collected and handled in accordance with any local laws. Proof-of-age checks may be enforced before accepting registration information from a user. All registration and internet usage information should only be used for legal purposes. Preferably, a privacy policy concerning the handling of profile information is formed, and each user may be told about the privacy policy before registering and during data collection. Preferably, there is further provided a certification party which checks the security, integrity, and privacy of the system to ensure that laws are not breached.

The system may also include an information limiting means for each user to individually limit the type and quantity of their own registration and internet usage information reported to the at least one receiving means. The type and quantity of profile information provided to each user may be related to the type and quantity of internet usage information or registration reported to the at least one receiving means. For example, if a user decides to stop the receiving means from receiving their internet usage information, the user in turn may be restricted from examining summary demographic information about other users during this time. In one embodiment, the system provides a number of different information reporting levels to the user in return for the user providing more or less profile information about themselves. In another embodiment, a user can choose to progressively report further registration information or internet usage information in return for progressively receiving more advanced querying, searching and access to the demographic information of other users. A user may therefore keep control of the amount of information provided, and gradually provide more information when they feel comfortable to do so.

The at least one receiving means may comprise a first receiving means for receiving the registration information, and a second receiving means for receiving the internet usage information. The registration information, internet usage information, and profile data set may be stored on one or more storage means.

Profile information provided to a third party may be different to profile information provided to each user, although both sets of information would be obtained from the same profile data. The profile information provided to a third party may comprise demographic information derived purely from the registration information. The profile information may also comprise the internet usage information. Profile information may be provided to the third party in return for some form of payment. For example, an advertiser might use the profile information to direct advertising to users who are more likely to be interested in the contents of the advertising based on their demographic profile or internet usage habits. The profile information can thus be used to avoid indiscriminate distribution of advertising or promotions, or so-called “spamming”. In another example, computer programmers may use the profile information to examine which sites relating to programming are popular in the context of the surfing habits of the other registered programmers.

The profile information may also be used by a third party to develop a more comprehensive picture of the web surfing patterns and interests of the users. The profile information may also be used to assess the interests of a particular demographic with respect to different subject matter: the web pages which are looked at by users; how long the users spend on each web page; the links users use to navigate the web site; or the demographic profiles of users who read a given web page. It will be understood that the profile information may be used to determine many other types of web site performance characteristics. Such information is extremely valuable to web site designers as it allows them to tailor a web site structure to maximise its effectiveness and attractiveness to one or more demographics that correspond to the customer profiles of an organisation. For example, a web site may be altered to attract web users with a particular demographic profile, or to enhance the exposure of particular web site features. Any subsequent alterations to a web site could be objectively tested by examining profile information acquired after alterations were made.

The profile information provided to a user may be limited to profile information obtained from the user's own profile data. For example, profile information may consist of a record of all internet sites visited by the user in a given time period. Each user may also be given the option of being provided with profile information about other users. For example, the profile information provided to each of the users may show the internet usage habits of users matching a demographic profile specified by a user. Thus, at least some embodiments of the present invention have the advantage that internet users can be encouraged to provide personal information in return for receiving profile information about themselves and/or other users, while the profile information can also be used by a third party for commercial purposes.

The information providing means may comprise one or more searching facilities for searching through the profile information based on at least one predetermined selection criterion. Information may be provided in the form of a report. Examples of reports generated in response to a search request include:

most visited sites for given user demographic profile;

user demographic profiles associated with a set of given sites;

web sites most visited by the users;

web links most visited by the users;

a list of the most popular web sites related to a particular topic;

most effective links that take users to other web sites;

web sites most bookmarked by the users;

web sites giving the most return visits by the users;

most popular keywords associated with a given demographic profile;

user keywords associated with most used links;

most popular forms;

time spent by users in sites;

number of links clicked on by users in a given site;

pages spent the most time on by users; or

a clustering report—which products a user having a given demographic profile is interested in, and which products the user is not interested in.

The searching facility allows each user to limit the scope of the profile information provided and to isolate information which is of particular interest. The profile information may be provided in a range of different forms, including a summarised form, an aggregated form, or raw data extracted from the profile data. Any means of presenting data may be used when providing profile information to a party, including: graphical, such as charts, graphs, drawings, or maps; textual, such as spreadsheets, reports, lists, or tables; or multimedia.

When the registration information of a user is received, the profile generating means may associate the information with a unique client identifier. Any subsequent information received from the user, such as internet usage information, is preferably accompanied with the client identifier in order to link the internet usage information with the registration information.

The internet usage information may be used in conjunction with the registration information for the purpose of developing detailed marketing information, which can then be retailed to another party such as a marketing or advertising company.

The internet usage information may be generated by known web browsers which keep a “history” file with URLs of web sites visited. Alternatively, the invention may further comprise a collection means for collecting internet usage information from a user, and for sending the internet usage information to the second receiving means. The collection means may be a computer program operating in tandem with a user's web browser. The collection means may send each piece of internet usage information directly to the second receiving means as it is collected. Alternatively, the collection means may store batches of internet usage information and periodically send the batches to the second receiving means.

The storage means for storing each profile may store the profiles on a computer readable medium, and may include a computer database. The information providing means may comprise any means of dispensing information. The information providing means may comprise an online computer server suitable for providing information over the internet, but may be provided in print or other media. Since the profile information available to users and a third party may be different, the information providing means may comprise an information processing means for determining the type and volume of information to be provided to each party. For example, it may not be appropriate to provide certain aspects of the profile information to a third party. Furthermore, each party may only require specific aspects of the profile information, depending on the application.

The information providing means may comprise a first information providing means and a second information providing means. There may also be one or more additional information providing means. For example, a first information providing means may comprise a web-based server for use by internet users, while a second information providing means may comprise a mailout facility for mailing out specific aspects of the user profile information in response to a request by another party. One embodiment of an information providing means comprises a mailout facility which only provides information to third parties in response to requests for specific information. The mailout facility may enable third parties to be charged according to the type and volume of profile information provided. The mailout facility may employ any form of communication, such as an internet connection, email, telephone, telex, or non-electronic mail.

The information providing means may comprise a history display means for displaying each of the web sites visited by a user (the so-called “navigation history”) over a predetermined period of time. Preferably, the history display means is arranged such that each internet user is only able to view their own navigation history. However, the navigation histories of at least one of the users may be provided to a third party. The history display device may provide a visual picture of the navigation history of a user. The visual picture may be displayed in a web map format. Such a display device provides the user with a “cyber-atlas” of their internet travels and may make it easier to understand how one idea led to another, or to backtrack at a later date. The history display device may provide a visual picture in a two-dimensional format and/or a three-dimensional format. A web map displayed by the history display device may include nodes which are each a graphical representation of either a web site or an object visited in a web site. A node may be hyperlinked to an object represented by the node. This would enable a user to easily return to a site visited earlier by simply clicking on the appropriate hyperlinked node in the web map. The history display device may obtain data for the navigation history from a history file generated by a web browser. The history display device may be offered as a free service to users, and provides an incentive for users to divulge registration information and internet usage information.

The system may further comprise a third receiving means for receiving miscellaneous additional information or communications reported from each user. The communications or additional information may relate to one or more of the following:

a request for help or problem-solving tips;

an order for a product or service; or

a comment on a web site visited by a user, or

a vote in an election or poll.

The client identifier may be assigned to any communications or additional information reported by a user and added to the appropriate profile data. Preferably, the client identifier is assigned by the collection means (where it is provided). Once a user's communications or additional information are added to the appropriate profile data, other parties may have access to at least part of the communications or additional information via the profile information. For example, each of the users may be provided with comments from one of the users, such as comments about a web site. The information providing means may provide a forum in which users' comments about web sites can be accessed by each of the users. In another example, the information providing means may provide the results of an election or poll held for the users. The election or poll results may include a demographic breakdown of trends in the results. Such information may also be provided to a third party. All information provided to users by the information providing means may be presented in either graphical, textual, or multimedia formats, or a combination of two or more of these.

Profile information may be provided to each party as a result of executing a computer program, function or routine which communicates with the information providing means through an application programming interface (API). Similarly, the internet usage information and registration information may be collected by executing a computer program, function or routine which communicates with the at least one receiving means through an API. Further, the navigation history may be displayed by executing a computer program, function or routine which communicates with the history display means through an API. Furthermore, profile information may be generated by executing a computer program, function or routine which communicates with the profile generating means.

A third aspect of the invention provides a computer readable medium storing instructions for controlling at least one computing device to provide profile information about at least one internet user in accordance with the method of the first aspect of the present invention.

A fourth aspect of the invention provides a display system including means for graphically displaying navigation history of an internet user. The display system may construct a visual display of the navigation history using history data provided by a web browser. Alternatively, the system may construct a visual display of the navigation history using data provided from an external source, such as the information providing means provided by the first aspect of the invention. The display system may provide a graphic computer display with one or more windows. Web pages or web sites visited by the user may be represented in a web map on the graphic computer display as nodes in the form of icons or shapes. Hyperlinks clicked on by a user may be represented in the graphic display by lines between representations of linked web objects. Arrowhead on the lines may be used to indicate the direction of travel between web objects. Predetermined nodes may be emphasised in the web map. For example, a node representing a web site or web page may be emphasised by making it larger than other nodes in the web map, or by using an icon which changes colour and/or shape. A node may be emphasised in response to a request from a third party, such as an owner of a web site corresponding to the node. The node may be emphasised in return for some form of payment from the third party.

In another embodiment, the display system constructs a graphic computer display comprising a bookmark filing system. A bookmark in a web browser is a record of a web site address which can be used to link directly to the web site of interest. The bookmark filing system may include an information tree with a range of categories of interest and sub-categories of interest arranged in a tree structure. A user may assign one or more bookmarks to selected categories or sub-categories in the tree.

The navigation history may be displayed by executing a third party program, function or routine which communicates with the display system through an application programming interface.

A fifth aspect of the invention provides a computer readable medium storing instructions for controlling a computing device to graphically display a navigation history of an internet user.

In order that the present invention may be more clearly understood, embodiments of the invention will now be described with reference to the accompanying drawings.

### BRIEF DESCRIPTION OF THE DRAWINGS

FIG. 1 is a block diagram showing the flow of information in an embodiment of a system according to the present invention.

FIG. 2 is a first embodiment of the user system shown in FIG. 1.

FIG. 3 is a second embodiment of the user system shown in FIG. 1.

FIG. 4 is a flow chart of an embodiment of a method according to the present invention.

FIG. 5 shows an example of a navigation history graphic display.

### DETAILED DESCRIPTION OF THE DRAWINGS

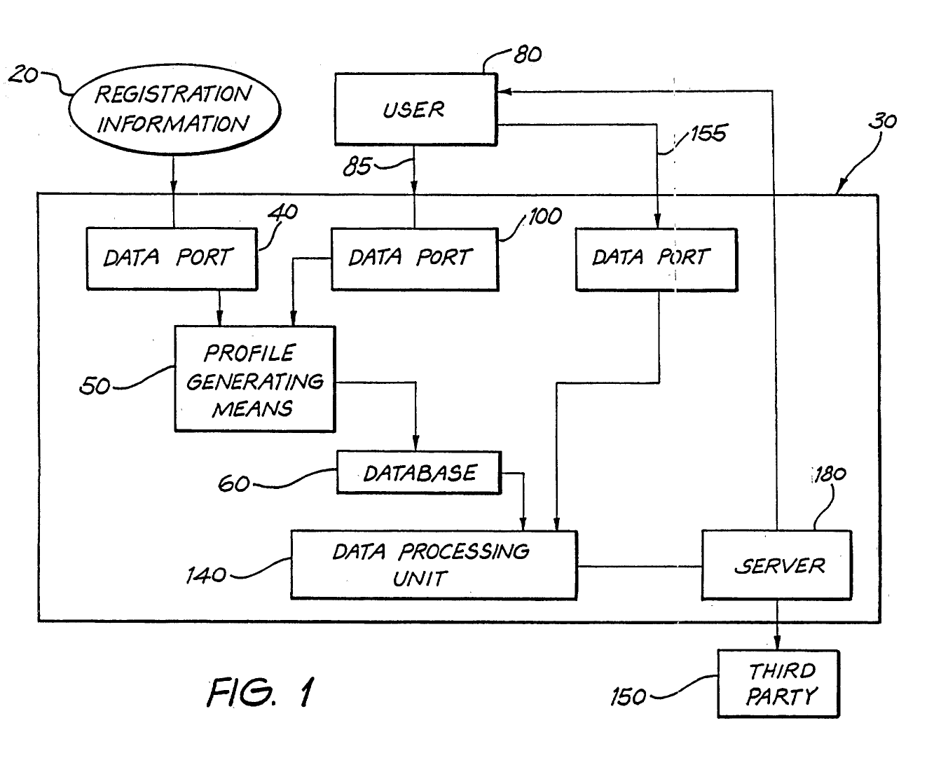

An embodiment of a system and a method for collecting profile information about a plurality of internet users, and providing the at least some of the information to the users and to at least one third party will now be described with reference to FIGS. 1 to 5.

The first step 10 of the method occurs when an internet user submits predetermined registration information 20 to a receiving means of a second party. In this example, the receiving means includes a first data port 40. The first data port 40 may be any type of communications channel, including one or more of the following: an internet connection; email; facsimile; telex; telephone, or non-electronic mail. A user might be given the option of submitting the registration information 20 when purchasing a new product, downloading new software, or accessing a particular web site or web object. A person skilled in the art will understand that there may be many other situations in which an internet user may be given the opportunity of submitting registration information. The registration information would be provided in answer to a questionnaire on a registration or survey form. The questionnaire may request personal data about the user relating to topics such as their age, sex, employment history, income level, geographical location, interests, educational background, or family makeup. It will be understood that many other types of information about the user may be requested.

Once a user's registration information is received by the second party 30 via the first data port 40, a second step 45 of the method comprises passing the information 20 to a profile generating means 50 where a file is created for the information. The profile generating means 50 also assigns a client identifier to the file. The file is then stored on a database 60. From this point, all information or communications sent by a user should be accompanied by the user's client identifier, enabling it to be associated with any information provided earlier, such as registration information. In order to begin receiving internet usage information, the user should acquire a collection mean, which in this example is software 70 for collecting information, and is supplied by the second party. The software 70 may be downloaded from a predetermined web site or may be automatically downloaded in the form of a browser plugin or Java program. The software 70 for collecting information is stored on a user's PC 80 and is designed to record at least part of the operation of a web browser 90 also stored on the PC 80. In this embodiment, the collection software 70 collects information about which links the user has clicked on and which sites the user has visited by the web browser 90, and sends this “history” data 85 (item by item or in batches) over the internet together with the appropriate client identifier to a second data port 100 (third method step 110). The history data 85 is then added to the user's registration information 20 in the fourth method step 120 by the profile generating means 50, and stored as raw profile data on the database 60 in the fifth step 130.

The raw profile data is then processed by a data processing unit 140. The data processing unit 140 may be used to prepare the data in order to present it in a particular format, and to limit the type and quantity of information provided, depending on the party receiving the data. For example, the data processing unit 140 could be a software program instructed to limit the amount of personal user information released in order to protect the privacy and security of each user. In another example, the data processing unit 140 searches through the raw profile data on the database 60 and presents specific information in response to a search request from a user or a request for information from a third party 150. User-generated requests 155 for information can be sent from the collection software 70 and sent to the data processing 140 unit via a third data port 160. The collection software 70 automatically labels the user-generated request 155 with the user's client identifier so that the data processing unit 140 can send the appropriate information back to the correct user. Information is sent in a sixth step 170 from the second party 30 to each user's PC 80 by a computer server 180 which receives processed data from the data processing unit 140. The server can also be used to send information to the third party 150, but alternative communication channels could also be used. For example, data supplied by the data processing unit 140 may be mailed directly by email or non-electronic mail to the third party 150.

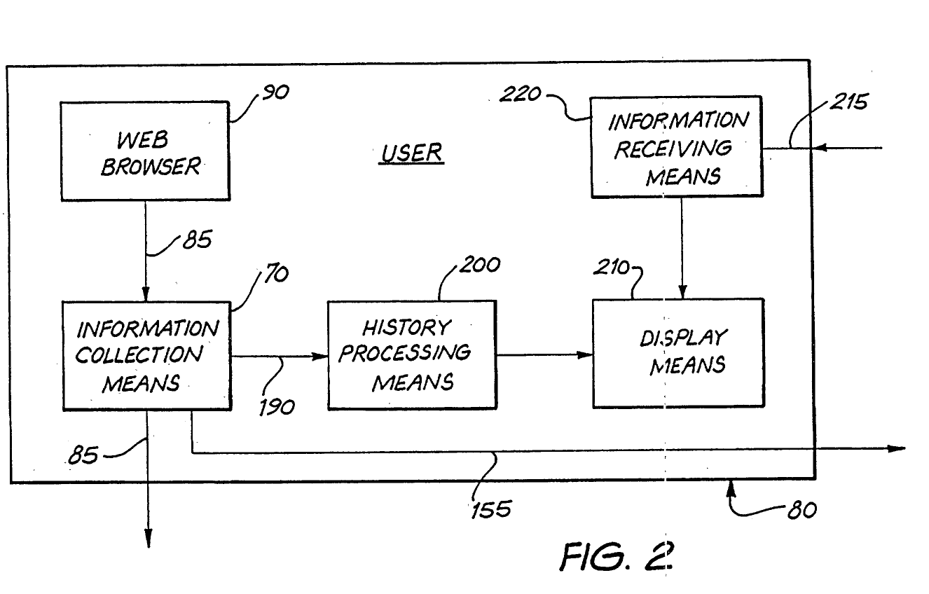

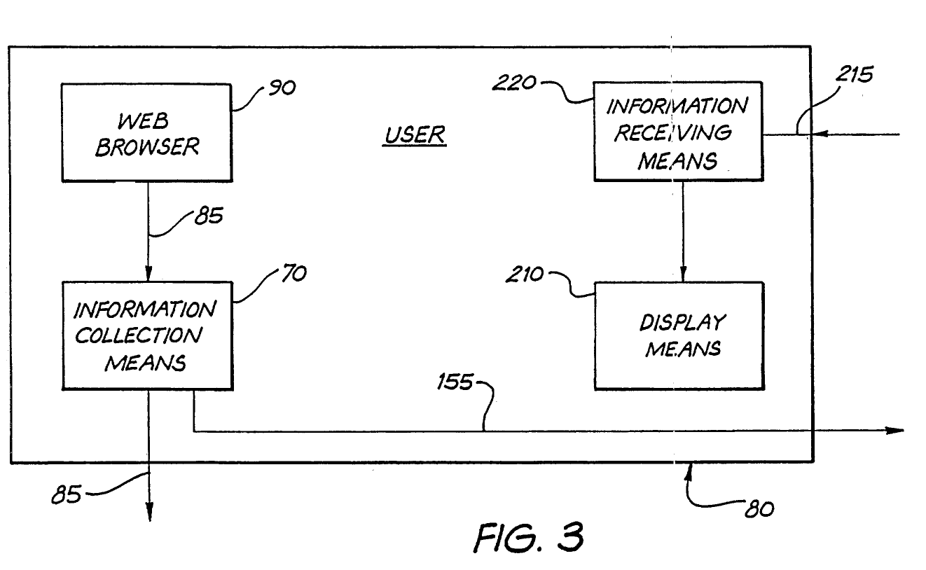

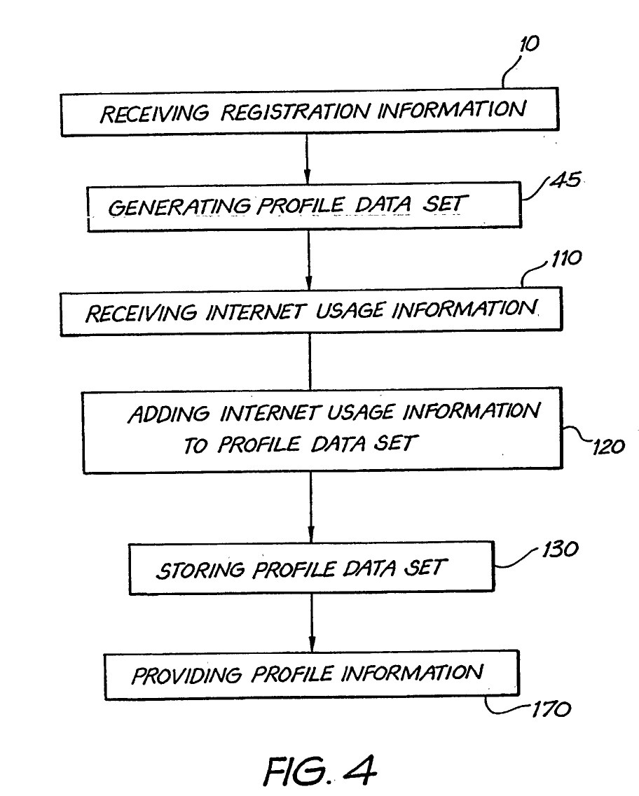

A first embodiment of a portion of the user's PC 80 is shown in FIG. 2. A user's history data 85 generated by a web browser 90 is collected by the collection software 70, which periodically sends a first stream of history data 85 to the second data port 100, and a second stream of history data 190 to a history processing means 200. The collection software 70 transmits user-generated requests via a third data stream 155. The history processing means 200 processes the history data 85 and prepares it for presentation on a graphic display means 210, such as the screen on a computer display. Profile information about the user and other users is received through a data input channel 215 by an information receiving means 220 from the server 180, and also sent to the graphic display means 210. In a second embodiment of a user's PC 80 (FIG. 3), the display means 210 receives all data input from the server 180 via the information receiving means 220, rather than directly from the information collection means 70. The first embodiment (FIG. 3) includes a history processing means 200, while the second embodiment (FIG. 4) has no such facility. The second embodiment receives all data pre-processed by the centrally-located data processing unit 140 of the second party 30.

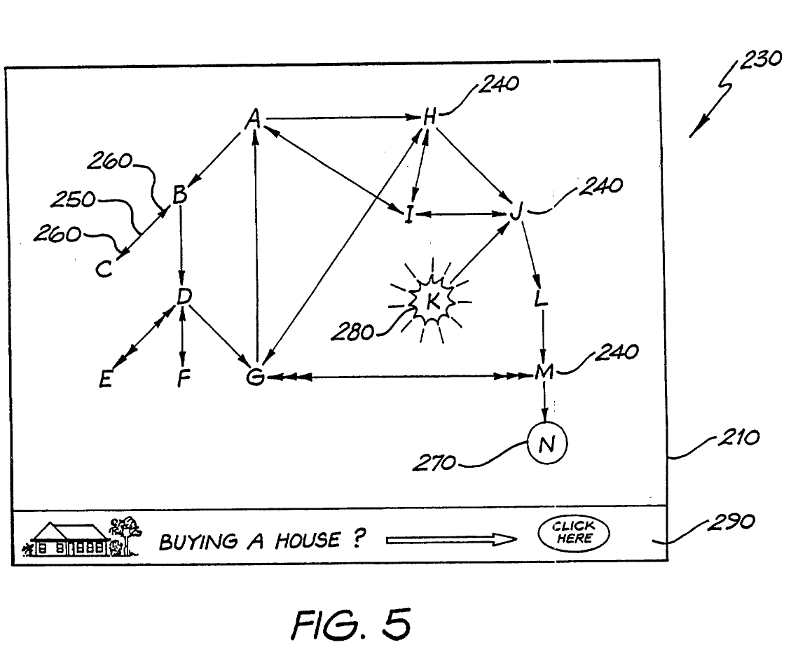

In both embodiments of the user's PC 80, history data is processed to provide a history map of a user's internet travels. An example of a history map 230 displayed on a graphic display means 210 is shown in FIG. 5. The graphic display means 210 may comprise a computer screen, or one of a plurality of windows on a computer screen. Each node 240 represented by a letter A, B, C, . . . N is the name of a web page visited by the user, and each arrow 250 shows web links which were taken between each web page. The direction of each link is shown with arrowheads 260. The number of arrowheads on a link indicates the number of times that link has been followed. For example, the user has linked between nodes G and M three times. It can also be seen that the user started at node A, travelled to B, and then to C, but linked back to B before linking to D. Each web page represented in the history map 230 is hyperlinked to the corresponding web page. A user can therefore return to any web page represented in the history map by clicking on the appropriate node 240, such as “J”.

A circle around one of the nodes “N” indicates the last web page visited by the user. Node “K” is a corporately sponsored node which is emphasised by a border 280 in order to bring it to the user's attention. For example, node K might represent a web site being promoted by the owner. It will be appreciated the a node icon may be emphasised in many other ways. Any node may be emphasised in return for a sponsorship fee, providing an additional form of revenue for the second party.

Advertising 290 is provided in a strip 300 at the bottom of the history map 230. The advertising may appear at predetermined times, or may constantly be displayed in the map 230. It will be understood that advertising, promotions, or messages may be presented in many different ways on the graphic display means 210, such as in other windows, formats, or media. For example, advertising could also be displayed when profile information is provided to a user, or when a user submits either a query, communications, or information to the second party 30.

It will be appreciated by a person skilled in the art that embodiments described may be implemented by appropriate computer hardware and software.

It will also be appreciated by a person skilled in the art that the invention is not limited to applications on the internet, but could be used on any other private or public access network.

It will also be appreciated by a person skilled in the art that numerous variations and/or modifications may be made to the present invention as shown in the specific embodiments without departing from the spirit or scope of the invention as broadly described. The present embodiments are therefore to be considered in all respects to be illustrative and not restrictive.

The claims defining the invention are as follows

1. A system for providing profile information about at least one internet user, the system comprising:
at least one receiving means for receiving internet usage information and registration information about each of the at least one internet users;
a profile generating means for generating a profile data set for each of the at least one internet users from the registration information and internet usage information;
an information providing means for providing at least one party with profile information obtained from at least one profile data set, wherein the at least one party includes each of the at least one internet users.

2. The system of claim 2, wherein the at least one party further comprises at least one third party which does not supply internet usage information.

3. The system of any one of the preceding claims, wherein the registration information is voluntarily supplied by the at least one user.

4. The system of any one of the preceding claims, wherein the registration information comprises at least one of the following items of information about the user: age; sex; employment history; income level; geographical location; interests; educational background; or family makeup.

5. The system of any one of the preceding claims, wherein the internet usage information comprises a record of at least one internet site visited by a user.

6. The system of any one of the preceding claims, wherein the internet usage information comprises a record of each hyperlink clicked on by a user while using a predetermined web browser.

7. The system of any one of the preceding claims, wherein the profile information provided to a user includes at least some of the profile information of at least one other user.

8. The system of any one of the preceding claims, wherein the information providing means includes a searching tool for each user to search through the profile information and select specific information based on at least one predetermined search criterion.

9. The system of any one of the preceding claims, wherein the internet usage information of a user is associated with a unique client identifier before being received by the at least one receiving means.

10. The system of any one of the preceding claims, wherein the system further comprises a collection means for collecting the internet usage information of a user and sending the internet usage information to the at least one receiving means.

11. The system of claim 10, wherein the collection means periodically sends batches of internet usage information to the at least one receiving means.

12. The system of any one of the preceding claims, wherein the system further comprises a storage means for storing profile information.

13. The system of claim 12, wherein the storage means stores the profile information on a computer readable medium.

14. The system of any one of the preceding claims, wherein the information providing means includes a computer server.

15. The system of any one of the preceding claims, wherein the information providing means includes a display means for graphically displaying a navigation history of an internet user.

16. The system of any one of the preceding claims, wherein the system further comprises an information limiting means for a user to selectively limit the type and quantity of registration information and internet usage information received by the at least one receiving means.

17. The system of claim 16, wherein the limiting means can be used to stop the receiving means from receiving the user's internet usage information for a period of time, and during this period of time the user is in turn prevented from receiving profile information.

18. A computer readable medium storing instructions for controlling at least one computing device to provide profile information about at least one internet user in accordance with the system of any one of claims 1-17, 38, 39, or 44.

19. A display system for comprising a means for graphically displaying a navigation history of an internet user.

20. A method of providing profile information about at least one internet user, the method comprising the steps of:
receiving registration information from each of the at least one internet users;
receiving internet usage information about each of the at least one internet users;
generating a profile data set for each user from the registration information and internet usage information;
providing at least one party with profile information obtained from at least one profile data set, wherein the at least one party includes each of the at least one internet users.

21. The method of claim 20, wherein the at least one party further comprises at least one third party which does not supply internet usage information.

22. The method of any one of claims 20-21, wherein the registration information is voluntarily supplied by the at least one user.

23. The method of any one of claims 20-22, wherein the registration information comprises at least one of the following items of information about the user: age; sex; employment history; income level; geographical location; interests; educational background; or family makeup.

24. The method of any one of claims 20-23, wherein the internet usage information comprises a record of at least one internet site visited by a user.

25. The method of any one of claims 20-24, wherein the internet usage information comprises a record of each hyperlink clicked on by a user while using a predetermined web browser.

26. The method of any one of claims 20-25, wherein the profile information provided to a user includes at least some of the profile information of at least one other user.

27. The method of any one of claims 20-26, wherein the information providing means includes a searching tool for each user to search through the profile information and select specific information based on at least one predetermined search criterion.

28. The method of any one of claims 20-27, wherein the method further comprises a step of collecting the internet usage information of a user and sending the internet usage information to the at least one receiving means.

29. The method of any one of claim 28, wherein the collection step further comprises associating a unique client identifier with the internet usage information of each user before sending the internet usage information to the at least one receiving means.

30. The method of claim either claim 28 or 29, wherein the collection step comprises periodically sending batches of internet usage information to the at least one receiving means.

31. The method of any one of claims 20-30, further comprising a step of storing the profile information in a storage means.

32. The method of claim 31, wherein the storage means stores the profile information on a computer readable medium.

33. The method of any one of claims 20-32, wherein the information providing means includes a computer server.

34. The method of any one of claims 20-33, wherein the information providing means includes a display means for graphically displaying a navigation history of an internet user.

35. The method of any one of claims 20-34, further comprising a step of limiting the type and quantity of registration information and internet usage information received by a user in response to a limiting instruction from the user.

36. A computer readable medium storing instructions for controlling at least one computing device to provide profile information about at least one internet user in accordance with the method of any one of claims 20-35.

37. A method of displaying a navigation history of an internet user wherein the navigation history is displayed graphically.

38. The system of any one of claims 1 to 17, wherein a user can progressively report further registration information or internet usage information in return for progressively receiving more or different profile information.

39. The system of any one of claims 1 to 17 or 38, wherein profile information is provided to each party in a summary form.

40. The method of any one of claims 20-35, wherein profile information is provided to each party in summary form.

41. The system of claim 19, wherein the navigation history is displayed in a web map.

42. The system claim 41, wherein objects and/or web sites are represented as nodes in the web map.

43. The system claim 42, wherein one or more of the nodes are emphasised.

44. The system of either claim 10 or 11, wherein the collection means associates a unique client identifier with the internet usage information.

45. The method of claim 37, wherein the navigation history is displayed in a web map.

46. The method of claim 45, wherein objects and/or web sites are represented as nodes in the web map.

47.The method of claim 46, wherein one or more of the nodes are emphasised.

48. A system for providing profile information about at least one internet user, substantially as herein described with reference to the accompanying drawings.

49. A computer readable medium storing instructions for controlling at least one computing device to provide profile information about at least one internet user, substantially as herein described with reference to the accompanying drawings.

50. A display system for comprising a means for graphically displaying a navigation history of an internet user, substantially as herein described with reference to the accompanying drawings.

51. A method of providing profile information about at least one internet user, substantially as herein described with reference to the accompanying drawings.

52. A method of displaying a navigation history of an internet user wherein the navigation history is displayed graphically, substantially as herein described with reference to the accompanying drawings.
